(19) United States
(12) Patent Application Publication
(10) Pub. No.: US 2025/0229448 A1
(43) Pub. Date: Jul. 17, 2025

(54) CUTTING MACHINE WITH IMPROVED LOG FEED CHANNELS

(71) Applicant: GAMBINI S.P.A., Milano (IT)

(72) Inventors: Paolo LAZZARESCHI, LUCCA (IT); Giovanni BUFFA, Ponte Buggianese PISTOIA (IT); Fabio PICCHI, Lammari LUCCA (IT)

(73) Assignee: GAMBINI S.P.A., Milano (IT)

(21) Appl. No.: 19/020,043

(22) Filed: Jan. 14, 2025

(30) Foreign Application Priority Data
Jan. 16, 2024 (IT) 102024000000663

(51) Int. Cl. B26D 7/06; B26D 3/16; B26D 7/01; B26D 7/02; B26D 7/18

(52) U.S. Cl. CPC B26D 7/0683; B26D 3/161; B26D 7/02; B26D 7/0625; B26D 7/18; B26D 2007/013; B26D 2210/11

(57) ABSTRACT

A cutting machine with improved log feed channels includes a plurality of feed channels of logs, a blade assembly for cutting logs, and a discharge assembly of final rolls and head and end trims, wherein every feed channel includes a clamp and a plurality of pushers, chain-moved, for feeding the logs in the clamp, wherein every feed channel includes a pair of chains and every pusher is jointly connected to both the chains of the pair of chains, wherein every chain of the pair of chains has a closed-loop extension defined by four pinions, describing an upper feed branch, a descent branch, a lower return branch and an ascent branch of the pusher.

The present invention relates to a cutting machine with improved log feed channels.

In the production of rolls or the like made of paper towels and/or hygienic paper, the so-called “tissue paper,” the process begins in a rewinding machine with the formation of paper rolls wound on sticks of a preselected diameter and a of certain height, the so-called “logs”. Subsequently, individual shorter final rolls, the so-called “small rolls”, must be cut to the required size, ready for distribution and final use by the consumer.

Cutting logs to a predetermined size for the production of final rolls is performed on a cutting machine, which receives a plurality of logs step by step in succession, generally across multiple parallel channels, so that each is cut to the precise required size.

This operation is typically carried out on cutting machines generally through rotating blades and results in the formation, for every log, of a plurality of segments of the required size, that is the final rolls, and at the opposite ends of the log, of two scrap segments, the so-called “end small rolls” or “trims”, which are unusable as being smaller than the final rolls.

In known cutting machines, the logs passing along the channels are fed by pusher elements, the so-called pushers, mounted on a chain that rotates on a pinion. Every chain bears a plurality of pushers spaced equidistantly along its extension, so that each pusher picks up a log and transports it towards the exit through the blade assembly.

The small rolls or trims must be removed during the evacuation of the final rolls cut to size from the cutting machine to avoid obstructing the packaging of the final rolls.

Complex devices have been developed to allow the removal of the trims, through the use of motorization means and/or movable conveyor planes, placed downstream of the cutting machine. Indeed, in known devices, exiting the cutting machine channels, there is an opening through which the trims fall by gravity. The final rolls, on the other hand, are passed beyond the opening, supported above by selectively activatable suction means and/or one or more lower sliding support planes provided with alternating movement and placed in phase with the logs feeding in the cutting channels.

Although these known devices function properly and correctly overall, they determine a complex machine construction (suction, releases, synchronization, etc.). Furthermore, a setup must be provided to all the accessory parts required for both the suction and transportation of the rolls, as well as the perfectly synchronized movement between the two planes and the conveyors for feeding the rolls and the trims in succession.

The complexity of the machine and its operation can further present some setup issues, with potential risks of jamming.

An object of the present invention is to make a cutting machine with improved log feed channels that solves the drawbacks described for the state of the art.

Another object of the present invention is to make a cutting machine with improved log feed channels with high reliability in structure and operation.

Another object of the present invention is to make a cutting machine with improved log feed channels that is particularly simple and functional, with reduced costs.

These objects, according to the present invention, are achieved by making a cutting machine with improved log feed channels, as set forth in claim 1.

Further features are provided in the dependent claims.

The features and advantages of a cutting machine with improved log feed channels, according to the present invention, will be more apparent from the following exemplary and non-limiting description referred to the attached schematic drawings, in which:

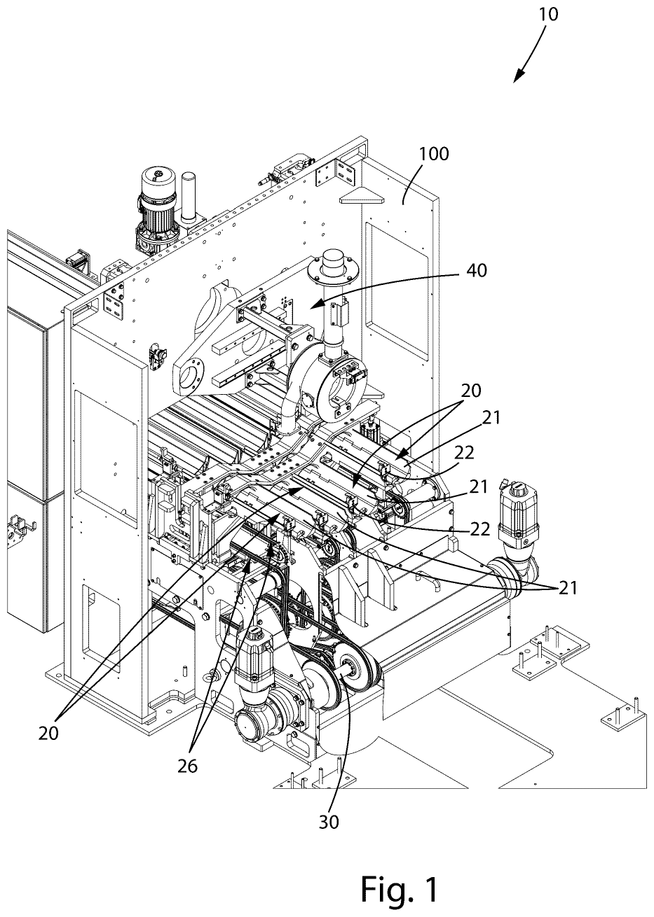

FIG. 1 is a partially cutaway perspective view of the feed channels and the blade assembly of the cutting machine of the invention;

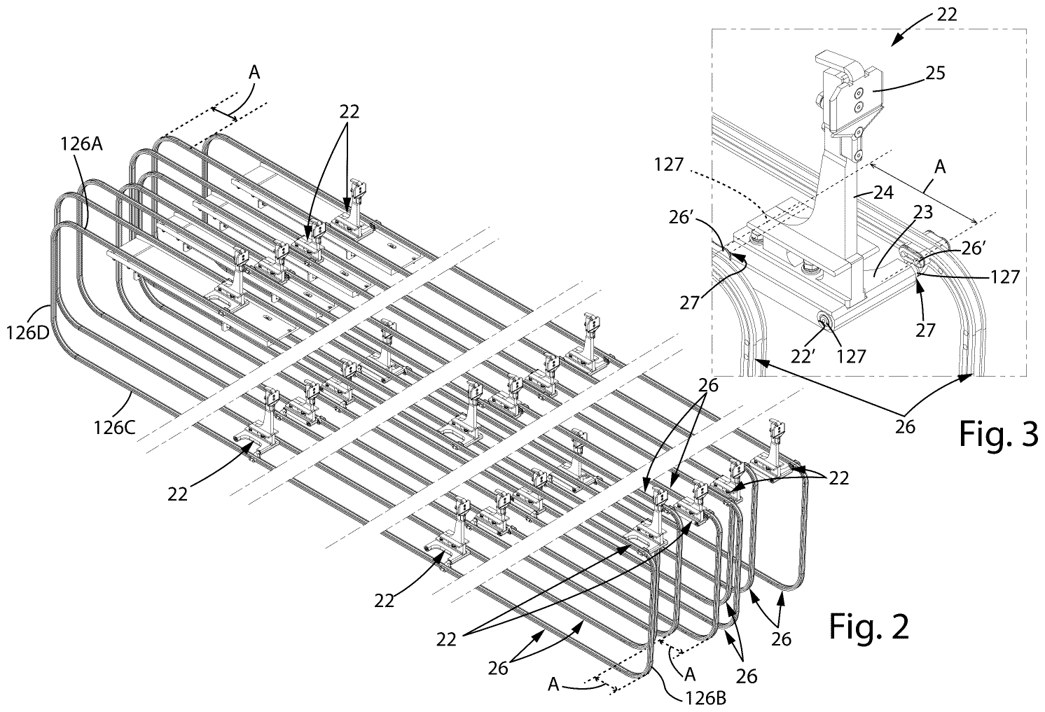

FIG. 2 shows the chains bearing the pushers of the cutting machine of the invention;

FIG. 3 shows an enlarged detail of a pusher in FIG. 2;

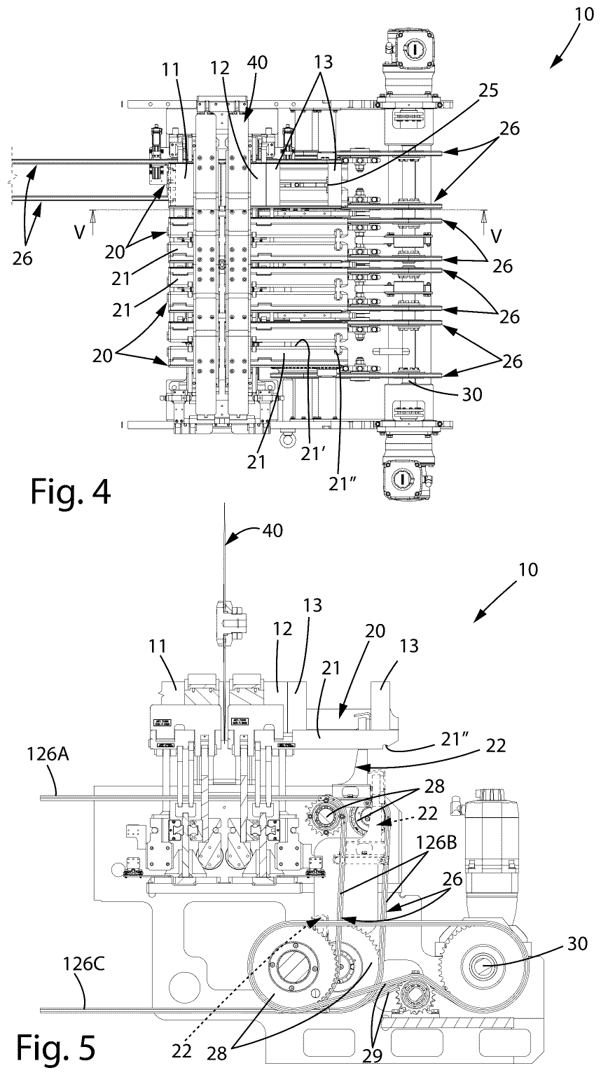

FIGS. 4 and 5 respectively show a plan view and a longitudinal section of the partially cutaway channels of the cutting machine, according to the invention;

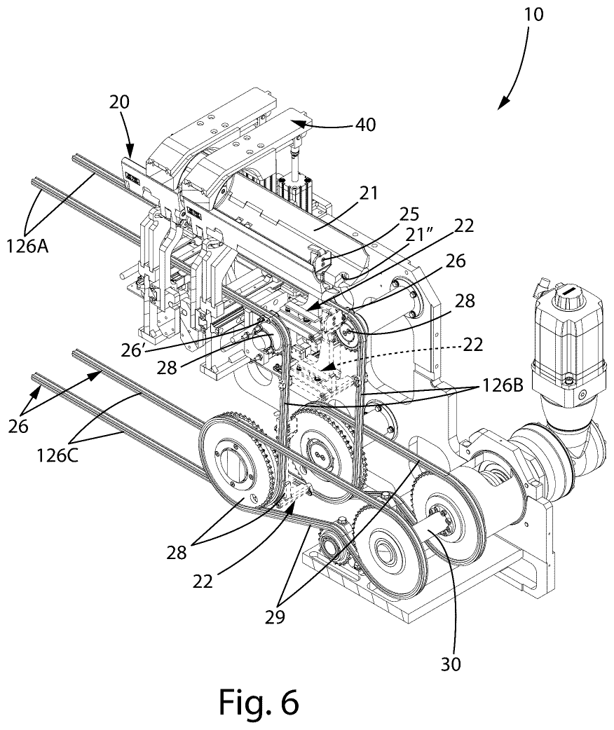

FIG. 6 shows an enlarged, partially cutaway perspective view of the first channel, the pair of chains associated with it, and their motorization of FIGS. 4 and 5;

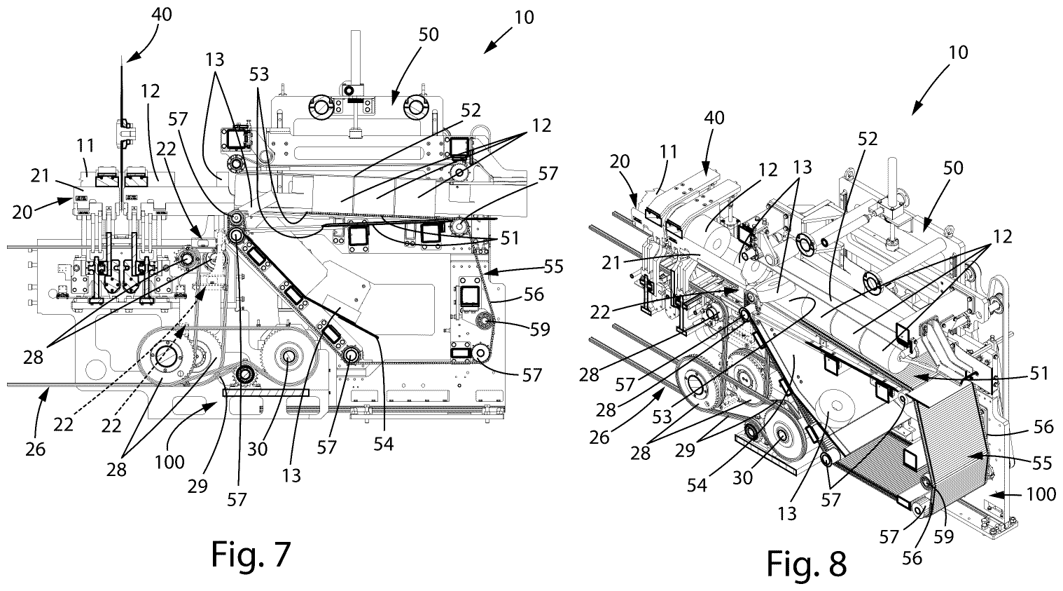

FIGS. 7 and 8 are partially sectioned views of the cutting machine of the invention, respectively elevated and perspective;

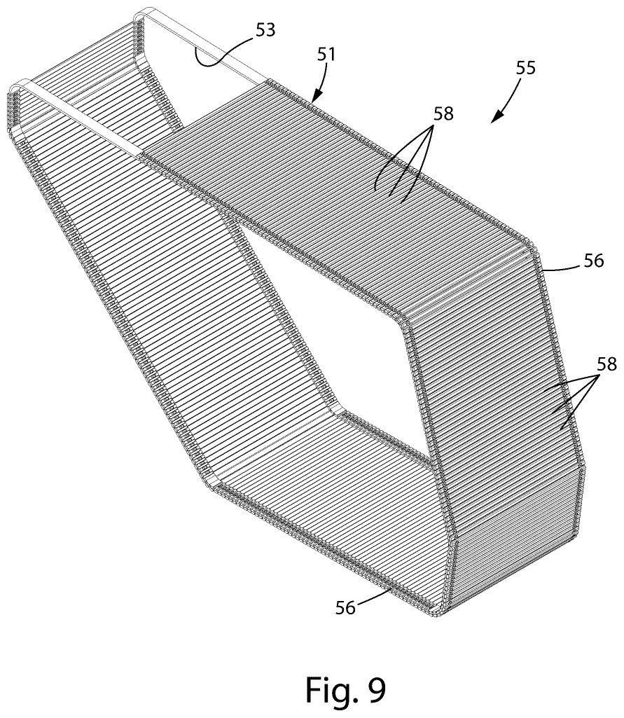

FIG. 9 shows the enlarged detail of the conveyor belt of FIGS. 7 and 8.

With reference to the figures, a cutting machine, generally indicated by 10, is shown, comprising, arranged on a frame 100, a plurality of feed channels 20 of logs 11, a blade assembly 40 for cutting logs 11, and a discharge assembly 50 of final rolls 12 and head and end trims 13.

Preferably, but not limited to, the cutting machine 10 comprises four feed channels 20, parallel to each other and arranged at different heights, according to known modes, so as to describe an arc of a circle with a radius comparable to the diameter of the rotating blade of the blade assembly 50 when viewed in a front plane.

Each of the feed channels 20 comprises a curved wall extending along the entire length of the channel itself, the so-called “clamp” 21, adapted to accommodate the logs 11 during feeding.

Every feed channel 20 also comprises a plurality of pushers 22, chain-moved, for feeding the logs 11 in the clamp 21.

Every pusher 22 of the cutting machine 10, according to the invention, as shown in FIGS. 2 and 3, comprises a base 23, from which a stem 24 extends orthogonally, bearing a pushing end 25 adapted to rest posteriorly against the log 11 to push it forward along the clamp 21.

Every feed channel 20 comprises a pair of chains 26 having the same extension, parallel to each other and placed side by side on either side of the base 23 of the pushers 22, opposite and parallel to the feed direction.

Every pusher 22 is jointly connected to both the chains of the pair of chains 26 respectively by at least one hinge 27.

Every chain of the pair of chains 26 has a closed-loop extension defined by four pinions 28, describing an upper feed branch 126A, a descent branch 126B, a lower return branch 126C and an ascent branch 126D of the pusher 22.

Every hinge 27 comprises a pivot 127, idly housed in a seat 22′ of the pusher 22, arranged transversely to the feed direction thereof. The pivot 127 is equipped with at least one end protruding from the base 23, constrained to a link 26′ of the respective chains in the pair of chains 26.

According to a preferred embodiment of the invention, in order to achieve a better balancing of the pusher 22, the chains in the pair of chains 26 are longitudinally misaligned along the feed direction of a predetermined extent A (FIG. 2).

In a preferred, non-limiting embodiment shown in FIG. 2, the pairs of chains 26, which are longitudinally misaligned, have the respective chains arranged specularly to the pair of chains placed side by side.

Every pusher 22 is jointly connected to both the chains of the pair of chains 26 respectively by two hinges 27, placed on opposite sides of the pusher 22. According to the invention, each of the two hinges 27 of each pusher 22 is connected to only one of the chains of the pair of chains 26.

Every hinge 27 comprises the pivot 127, idly housed in the seat 22′ of the pusher 22. Every pivot 127 is equipped with only one end protruding from the base 23, constrained to one of the links 26′ of the respective chains of the pair of chains 26.

In the preferred embodiment shown, the two hinges 27 are arranged on the base 23 in a diagonally-opposed position.

The predetermined extent A of the longitudinal misalignment between the chains of the pair of chains 26 is equal to the distance between the axes of the pivots 127 of the two hinges 27. Furthermore, the pivot 127 on the front side of the pusher 22, facing the feed direction thereof, is hinged to the chain of the pair of chains 26 arranged further ahead of the predetermined extent A relative to the other chain of the pair of chains 26.

This allows both hinges 27 of the pusher 22 to always be located at every moment in the same point along the extension of both chains of the pair of chains 26.

In the proximity of the descent branch 126B of the chains, the pusher 22 describes a descent trajectory parallel to the descent branches 126B of the pair of chains 26, which in the illustrated example is substantially vertical.

As known, the clamp 21 comprises a longitudinal slot 21′ along its longitudinal extension, through which the stem 24 of the pusher 22 slides, so that the pushing end 25 protrudes upwards towards the channel 20.

In a preferred embodiment of the invention, the clamp 21 comprises a transverse slot 21″ in the proximity of the outlet end, adapted to accommodate the pushing end 25 of the pusher 22 during the descent trajectory of the pusher 22 along the descent branch 126B, as shown, for example, in FIG. 1.

The transverse slot 21″ of the clamp 21 can be made, as in the example shown for example in FIG. 1, through an opening formed in the wall of the clamp 21, at a distance from its outlet end approximately equal to the height of the trims 13.

In this way, when the pusher 22 passes throughs the clamp 21 during its descent movement, the end trim 13 of the exiting log 11 remains stationary on the clamp 21, no longer pushed by the pusher 22, until it is reached by the head trim 13 of the subsequent log 11, which moves close to it and is moved by its own pusher 22, which is still traveling along the feed branch 126A, and also pushes the end trim 13 of the previous log 11 to discharge it from the channel 20. In this manner, the head and end trims 13 of two subsequent logs 11 are discharged simultaneously from the channel 20.

The transverse slot 21″ could similarly be obtained by making the terminal part of the clamp 21 by two distinct pieces kept close together at a certain distance to form the transverse slot 21″.

According to a different embodiment, not shown, the end trim 13 can be actively discharged from the channel 20 by the pusher 22 associated with it, and at a different time from the head trim 13 of the subsequent log 11 fed in the channel 20.

FIGS. 4 and 5 respectively show a plan view and a longitudinal section of the partially cutaway channels 20. For illustrative purposes, the first channel 20 depicts a log 11 being cut, the already cut final rolls 12, the head trim 13 of the log 11 being cut, and the end trim 13 of the already cut log 11, pushed by the pusher 22 just before the position in which it starts the descent path through the transverse slot 21″. In order to exemplify the descent trajectory of the pusher 22 along the descent branch 126B of the pair of chains 26, the same pusher 22 is shown in Figures, by dashed line, in two further positions reached during the rotation of the chains, that is at the beginning of the descent branch 126B and at the beginning of the return branch 126C.

In FIG. 6, a partially cutaway perspective view is shown of the first channel 20, the pair of chains 26 associated with it, and their motorization.

Every chain of the pair of chains 26 is driven via its own belt 29, connected to one of the return pinions 28. All the belts 29 of the chains in all the channels 20 are connected to a single drive shaft 30.

The final rolls 12 cut to size by the blade assembly 40 in the channels 20 of the cutting machine 10 are advanced downstream of the channels 20 towards a packaging machine (not shown) on the discharge assembly 50. Instead, the head and end trims 13 must be removed.

The discharge assembly 50 of the cutting machine 10, according to the invention, comprises at least one conveyor plane 51, preferably associated above with an upper belt 52, or another friction element, to facilitate the feeding of the final rolls 12, and appropriately adjustable in distance from the conveyor plane 51 to be adaptable to the diameter of the cut final rolls 12.

According to the invention, the conveyor plane 51 is provided with at least one opening 53, having a size sufficient to allow the passage of the trims 13, through which the trims 13 are removed by gravity towards a chute 54 made below the conveyor plane 51.

The opening 53 is movable and synchronized with the movement of the pushers 22.

The conveyor plane 51 consists, in the example shown, of the upper branch of a loop-wound conveyor belt 55 provided with its own motorization 59, independent of the motorization 30 of the pushers 22.

The opening 53 therefore moves with the rotation of the conveyor belt 55 and is appropriately put in phase with the feeding the cut logs 11 in the channels 20, so as to be present at the beginning of the conveyor plane 51, i.e., immediately downstream of the outlet of the channels 20, synchronized with the discharge of the head and end trims 13 from the channel 20 due to the feeding of the pusher 22.

According to the preferred embodiment, wherein the conveyor belt 55 comprises only one opening 53, the speed of which is set so a as to make a complete turn corresponding to the feeding of every log 11, i.e., the time between the exit from the feed channel 20 of two subsequent pushers 22.

After the passage of the opening 53 at the beginning of the feed plane 51 and the resulting removal of the trims 13 by gravity through the same opening 53, the final rolls 12, cut to size and discharged from the channel 20 by the movement of the pusher 22, are pushed on the closed portion of the conveyor belt 55 and transported out of the cutting machine 10.

After all the final rolls 12 of a log 11 have been transferred on the conveyor plane 51, a new cycle begins with the step of removing the head and end trims 13, due to the presentation of the opening 53 at the beginning of the conveyor plane 51, synchronized with the movement of the pusher 22.

In the example, the conveyor plane 51 is made of two chains 56, which follow a closed-loop path guided by pinions 57, connected to each other by a plurality of approximately three hundred slats 58, preferably made of aluminium.

Alternatively, the conveyor plane 51 could be made by two toothed belts joined by slats or a single wide toothed belt with a square hole.

According to a preferred embodiment, shown in the figures, every channel 20 is associated with its own distinct conveyor belt 55.

Indeed, in FIGS. 7 and 8, a first conveyor belt 55 is shown, associated with the external channel 20, as well as a small, sectioned portion of the conveyor plane 55 associated with the channel placed side by side, not shown, which is located at a lower height than the external channel. The two conveyor belts 55 placed side by side therefore have the initial section of the conveyor plane 51 at different heights, but have the final section of the conveyor plane 51 at the same height to facilitate the passage of the final rolls 12 to the subsequent station. As a result, the two conveyor planes 51 placed side by side have different slopes. According to the preferred embodiment shown, for every feed channel 20, a distinct upper belt 52 is placed above the conveyor belt 55 to accompany the final rolls 12 towards the outlet, i.e., towards the subsequent packaging station.

Every upper belt 52 has the same movement of the conveyor belt 55 with which it is associated and has an adjustable height equal to the diameter of the cut final rolls 12. Therefore, the final rolls 12 are actively guided both from below and above in the discharge assembly 50.

The purpose of the upper belts 52 is to prevent the final rolls 12 from distancing from each other, losing the stroke with the conveyor belt 55, and risking falling into the gap ahead.

Without the upper belt 52, there would also be a risk of the final rolls 12 tipping over, particularly in cases where their diameter is significantly greater than the cut length.

The cutting machine with improved log feed channels which is the object of the present invention has the advantage of solving the drawbacks of the state of the art previously highlighted in a simple and functional way.

1. A cutting machine with improved log feed channels, comprising:
a plurality of feed channels of logs;
a blade assembly for cutting logs;
a discharge assembly of final rolls; and
head and end trims,
wherein every feed channel comprises a clamp and a plurality of pushers chain-moved for feeding the logs in the clamp, wherein every feed channel comprises a pair of chains (26) and every pusher is jointly connected to both the chains of the pair of chains, and
wherein every chain of the pair of chains has a closed-loop extension defined by four pinions, describing an upper feed branch, a descent branch, a lower return branch and an ascent branch of the pusher.

2. The cutting machine with improved log feed channels according to claim 1, wherein the chains of the pair of chains are longitudinally misaligned of a predetermined extent (A) along the feed direction.

3. The cutting machine with improved log feed channels according to claim 2, wherein that every pusher is jointly connected to both the chains of the pair of chains by two hinges, respectively, wherein every of the two hinges of every pusher is connected to only one of the chains of the pair of chains.

4. The cutting machine with improved log feed channels according to claim 3, wherein the two hinges are arranged on a base of the pusher in a diagonally-opposed position and with axes placed at a distance equal to the predetermined extent (A) of misalignment of the chains of the pair of chains.

5. The cutting machine with improved log feed channels according to claim 3, wherein every hinge comprises a pivot, idly housed in a seat of the pusher.

6. The cutting machine with improved log feed channels according to claim 2, wherein multiple pairs of chains are placed side by side and arranged specularly to each other.

7. The cutting machine with improved log feed channels according to claim 1, wherein the clamp comprises, in the proximity of the outlet end, a transverse slot, adapted to accommodate the pusher during the descent trajectory along the descent branch.

8. The cutting machine with improved log feed channels according to claim 1, wherein the discharge assembly comprises at least a conveyor plane of the final rolls provided with at least one opening of a size adapted to allow head and end trims to fall by gravity, wherein the opening is movable and synchronized with the movement of the pushers.

9. The cutting machine with improved log feed channels according to claim 8, wherein the conveyor plane consists of the upper branch of a loop-wound conveyor belt and provided with its own motorization independent of the motorization of the pushers.

10. The cutting machine with improved log feed channels according to claim 9, wherein every channel is associated with its own conveyor belt, wherein every conveyor belt has only one opening, wherein the speed of the conveyor belt is set so as to make a complete turn corresponding to the time between the exit from the feed channel of two subsequent pushers.

11. The cutting machine according to claim 9, wherein the discharge assembly comprises at least one upper belt placed above the conveyor belt at an adjustable distance, wherein the upper belt has the same movement of the conveyor belt.
